(19) United States
(12) Patent Application Publication
(10) Pub. No.: US 2014/0324706 A1
(43) Pub. Date: Oct. 30, 2014

(54) TERMINAL APPARATUS AND METHOD FOR USING DRM-ENCRYPTED MULTIMEDIA CONTENTS

(71) Applicants: Intellectual Discovery Co., Ltd., Seoul (KR); Inka Entworks, Inc., Seoul (KR)

(72) Inventor: Yoon Hwan PARK, Seoul (KR)

(73) Assignees: Inka Entworks, Inc., Seoul (KR); Intellectual Discovery Co., Ltd., Seoul (KR)

(21) Appl. No.: 14/265,525

(22) Filed: Apr. 30, 2014

(30) Foreign Application Priority Data
Apr. 30, 2013 (KR) 10-2013-0048265

(51) Int. Cl. G06Q 20/12

(52) U.S. Cl. CPC G06Q 20/1235
USPC 705/59

(57) ABSTRACT

A DRM contents using method of a terminal apparatus is provided. The method includes generating a refund list file including contents identification information upon DRM contents for which a user of the terminal apparatus has received a refund; if a use of first DRM contents is requested from the terminal apparatus, comparing first contents identification information corresponding to the first DRM contents with the contents identification information in the refund list file; and determining usability of the first DRM contents based on the comparison result.

### CROSS-REFERENCE TO RELATED APPLICATIONS

This application is based on and claims priority from Korean Patent Application No. 10-2013-0048265, filed on Apr. 30, 2013, the disclosure of which is incorporated herein in its entirety by reference.

### TECHNICAL FIELD

The present disclosure relates to a terminal apparatus and method for using DRM-encrypted contents; and, more particularly, to a terminal apparatus and method for using DRM-encrypted contents, capable of preventing an illegal use of DRM-encrypted contents for which a refund is made.

### BACKGROUND

As computer technologies are developed and popularized, most of general commercial contents (books, cartoons, records, films, broadcasts, newspapers, etc.), which are once produced, stored and managed in analog forms, are being digitalized.

Digital contents have persistent high quality which hardly deteriorates even if they are used repeatedly. Further, the digital contents are easy to copy and modify, and even a large capacity of literary works are easy to transfer and distribute in a short period of time through a high-speed communications network. Due to these characteristics and advantages of digital contents, analog literary works are being digitalized rapidly.

However, such advantages of the digital contents can also be factors that may infringe author's rights and profits. Since there is no difference in using a copied version and using an original version, motivation to purchase the original version may be weakened. Further, since the digital contents are easy to copy and modify without needing to gain author's consent, it may be easy to pirate the digital contents. Moreover, since the digital contents are easy to transmit and distribute, illegal copies may be widely spread through the Internet in an instant, disabling a legalistic control thereof.

These negative factors may reduce authors' morale and willingness to create their works, causing them to hesitate to digitalize their works. Accordingly, there has been a demand for technological protective measures for managing copyright efficiently while fully utilizing the advantages of digital.

To this end, in order to protect authors' rights and profits for the digital contents, a technology of applying DRM (Digital Rights Management) to the digital contents has been developed, and various DRM methods are used.

Here, DRM refers to a series of techniques for preventing illegal copy, protecting rights and profits of the subjects (contents creators, distributors, users, authors, etc.) participating in the lifecycle (i.e., creation, processing, distribution and consumption) of digital contents, and supporting billing and payment for using the digital contents.

A server that provides digital contents using a DRM method transmits encrypted digital contents, and a license server transmits a license to a legal user, thus allowing only the legal user to reproduce and print those digital contents. Here, the license may include digital contents encryption keys for use in decrypting the digital contents, digital contents permission information including information regarding the use of the digital contents, and so forth.

Meanwhile, conventionally, various DRM solution services such as time-limited contents service and repetition-limited contents service have been provided. Here, the time-limited service of DRM solution is a service using only the time information of a DRM file header, unlike the repetition-limited service. In this time-limited service, it is possible to use contents encrypted by a DRM method (hereinafter, simply referred to as “DRM-encrypted contents) by using a predetermined terminal apparatus within a set time period.

Conventionally, however, there has been a likelihood of misusing the characteristic of the time-limited service of the DRM solution, i.e., the fact that the DRM-encrypted contents can be used by using the predetermined terminal apparatus within the set time period.

For example, a customer may purchase DRM-encrypted contents to which a time-limited service is applied. Then, the customer may back up the purchased DRM-encrypted contents, which is stored in the terminal apparatus upon the purchase, into an external storage medium such as a PC, a USB, or the like, and, then, may request a refund to a contents provider. In such a case, in general, the contents provider may refund the customer after performing a series of processes including: making a remote access to a PC of the customer who has purchased the DRM-encrypted contents; requesting the customer to connect the PC and the terminal apparatus in which the purchased DRM-encrypted contents is stored; and deleting, from the terminal apparatus, the DRM-encrypted contents for which refund is requested.

However, if the refunding is completed, the customer may store the previously backed-up DRM-encrypted contents in their terminal apparatus again and use them.

### SUMMARY

In view of the foregoing problems, the present disclosure provides a terminal apparatus and method for using DRM-encrypted contents, capable of preventing, by generating a refund contents list in a terminal apparatus, an illegal use of DRM-encrypted contents for which a refund is already made.

However, the problems sought to be solved by the present disclosure are not limited to the above description and other problems can be clearly understood by those skilled in the art from the following description.

An exemplary embodiment of the present disclosure provides a DRM contents using method of a terminal apparatus, which includes: generating a refund list file including contents identification information upon DRM contents for which a user of the terminal apparatus has received a refund; if a use of first DRM contents is requested from the terminal apparatus, comparing first contents identification information corresponding to the first DRM contents with the contents identification information in the refund list file; and determining usability of the first DRM contents based on the comparison result.

In the embodiment, wherein the process of generating the refund list file comprises: sending, to a contents providing server, a request for investigating whether the user of the terminal apparatus has received a refund for DRM contents; requesting contents identification information of the DRM contents for which the user of the terminal apparatus has received the refund; generating the refund list file by using the received information upon whether the user has received the refund for the DRM contents and the contents identification information of the DRM contents for which the user has received the refund.

In the embodiment, the DRM contents using method further comprising: if the use of the first DRM contents is requested from the terminal apparatus, checking whether a refund flag is set in a header of the first DRM contents, wherein the process of comparing the first contents identification information of the first DRM contents is performed when the refund tag is found to be set.

In the embodiment, wherein in the process of determining the usability of the first DRM contents, based on the comparison result, if the first contents identification information is found to be included in the contents identification information in the refund list file, it is determined that the first DRM contents are not usable, and based on the comparison result, if the first contents identification information is found not to be included in the contents identification information in the refund list film, it is determined that the first DRM contents are usable.

An exemplary embodiment of the present disclosure provides a terminal apparatus using DRM contents, which includes: a storage unit configured to store therein a refund list file including contents identification information upon DRM contents for which a user of the terminal apparatus has received a refund; a control unit configured to, if a use of first DRM contents is requested from the terminal apparatus, compare first contents identification information corresponding to the first DRM contents with the contents identification information in the refund list file, and determine usability of the first DRM contents based on the comparison result.

In the embodiment, the terminal apparatus further comprising: a communication unit, wherein the control unit controls the communication unit to send, to a contents providing server, a request for investigating whether the user of the terminal apparatus has received a refund for DRM contents, and to request contents identification information of the DRM contents for which the user of the terminal apparatus has received the refund, and the control unit generates the refund list file by using the received information upon whether the user has received the refund for the DRM contents and the contents identification information of the DRM contents for which the user has received the refund.

In the embodiment, wherein if the use of the first DRM contents is requested from the terminal apparatus, the control unit checks whether a refund flag is set in a header of the first DRM contents, and the process of comparing the first contents identification information of the first DRM contents is performed if the refund tag is found to be set.

In the embodiment, wherein based on the comparison result, if the first contents identification information is found to be included in the contents identification information in the refund list file, the control unit determines that the first DRM contents are not usable, and based on the comparison result, if the first contents identification information is found not to be included in the contents identification information in the refund list film, the control unit determines that the first DRM contents are usable.

According to the exemplary embodiments of the present disclosure, it may be possible to prevent an illegal use of DRM-encrypted contents after a refund is already made for the contents. Thus, a contents provider can be guaranteed legitimate profit.

### BRIEF DESCRIPTION OF THE DRAWINGS

FIG. 1 is a block diagram illustrating a DRM system connected to a terminal apparatus in accordance with an exemplary embodiment of the present disclosure.

FIG. 2 is a block diagram illustrating a specific configuration of the terminal apparatus in accordance with an exemplary embodiment of the present disclosure.

FIG. 3 is a flowchart for describing a sequence of a refunding process in accordance with an exemplary embodiment of the present disclosure.

FIG. 4 is a flowchart for describing a method for generating a refund list file in accordance with an exemplary embodiment of the present disclosure.

FIG. 5 is a flowchart for describing a sequence of a process for preventing an illegal use of DRM-encrypted contents for which a refund is made.

### DETAILED DESCRIPTION

The advantages and features of the present disclosure and the ways to achieve them will become apparent from the following description of exemplary embodiments given in conjunction with the accompanying drawings. The exemplary embodiments will be described in detail so that inventive concept may be readily implemented by those skilled in the art. However, it is to be noted that the exemplary embodiments are not intended to be anyway limiting and various modifications may be made without departing from the technical concept of the present disclosure. The scope of the inventive concept will be defined by the following claims rather than by the detailed description of the exemplary embodiments.

In the following description, when there is a concern that detailed description of functions or configuration known in the pertinent art may hamper clear understanding of the inventive concept of the present disclosure, the detailed description thereof will be omitted. Further, the terms used in this document are defined in consideration of their functions in the exemplary embodiments of the present disclosure, and their definitions may be differed depending on intentions of users or operators or practices. Thus, the definitions of the terms used in this specification should be understood based on the entire disclosure of this document.

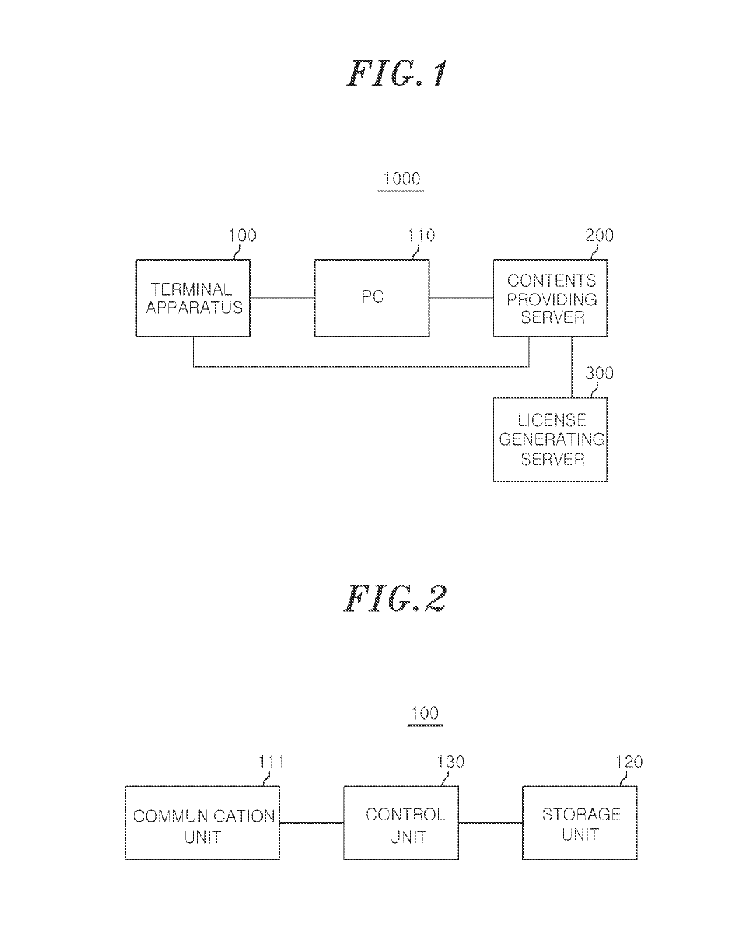

FIG. 1 is a block diagram illustrating a DRM system connected to a terminal apparatus in accordance with an exemplary embodiment of the present disclosure. Referring to FIG. 1, the system 1000 may include all or a part of a terminal apparatus 100, a PC 110, a contents providing server 200 and a license generating server 300. Prior to describing FIG. 1, it is assumed that contents encrypted by a DRM method (hereinafter, simply referred to as “DRM-encrypted contents”) is the same concept as DRM contents.

The contents providing server 200 may store therein various contents supposed to be provided to users. Here, the various contents may be stored by being encrypted by a DRM (Digital Rights Management) method through the use of encryption keys provided by the license generating server 300. Here, the DRM-encrypted contents may include, in a header thereof, a refund flag and contents identification information. In case of DRM-encrypted contents to which a time-limited service is applied, the DRM-encrypted contents may include, in its header, time period information in addition to the refund flag and the contents identification information.

The license generating server 300 may be configured as a server that generates and issues a license for the DRM-encrypted contents stored in the contents providing server 300.

The PC 110 may be connected to the contents providing server 200 through the Internet or the like. A user may connect the PC 110 to the contents providing server 200 through login or the like. Then, the user may download the DRM-encrypted contents from the contents providing server 200 and store the downloaded DRM-encrypted contents.

The terminal apparatus 100 may include a native unit configured to perform general functions as a terminal apparatus; and a DRM decryption unit configured to decrypt multimedia contents encrypted by a DRM method. Here, these functions of the terminal apparatus 100 may be performed in connection with a controller 130 of the terminal apparatus 100.

If the user drives an application program related to a download of DRM-encrypted contents, the native unit may download the DRM-encrypted multimedia contents stored in the PC 110 through a USB (Universal Series Bus) or the like and store them in a storage unit. Alternatively, the native unit may download the DRM-encrypted multimedia contents stored in the contents providing server 200 directly through Wi-Fi or the like.

If reproduction of the DRM-encrypted multimedia contents stored in the storage unit is requested from the application program, the DRM decryption unit may check whether a license is granted for the DRM-encrypted multimedia contents requested to be reproduced. In case that a license is granted for the DRM-encrypted multimedia contents requested to be reproduced, the DRM decryption unit may decrypt the DRM-encrypted multimedia contents by using the license. The decrypted contents may be sent to a multimedia player of the native unit, and the multimedia player may reproduce the decrypted contents.

Here, the terminal apparatus 100 may be implemented by any of various devices such as a smart phone, a tablet computer, a PDA (Personal Digital Assistants), PMP (Portable Multimedia Player), etc., capable of using DRM-encrypted contents.

FIG. 2 is a block diagram illustrating a specific configuration of the terminal apparatus in accordance with an exemplary embodiment of the present disclosure. Referring to FIG. 2, the terminal apparatus 100 may include all or a part of a communication unit 111, a storage unit 120 and the controller 130

The communication unit 111 enables communications between the terminal apparatus 100 and external devices. Here, the communication unit 111 may achieve connections to the external devices through LAN (Local Area Network) or Internet in a wireless or wired manner, through a USB (Universal Serial Bus) port, through a mobile communication network such as 3G or 4G, or a local area wireless communications technology such as NFC (Near Field Communication), RFID (Radio Frequency Identification) or Wi-Fi.

The storage unit 120 is configured to store various data and programs for use in operating the terminal apparatus 100. Here, the storage unit 120 may be implemented by a built-in storage such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk or a memory card, or may be implemented by a removable storage such as a USB memory or a CD-ROM.

The control unit 130 controls the overall operation of the terminal apparatus 100. To elaborate, the controller 130 may control all or a part of the communication unit 111 and the storage unit 120.

Particularly, the control unit 130 may be configured to perform operations for generating a refund list file in the terminal apparatus in connection with a refund list generating program and for preventing an illegal use of DRM-encrypted contents for which a refund is made.

Hereinafter, referring to the configurations of FIG. 1 and FIG. 2, various exemplary embodiments of the present disclosure will be discussed.

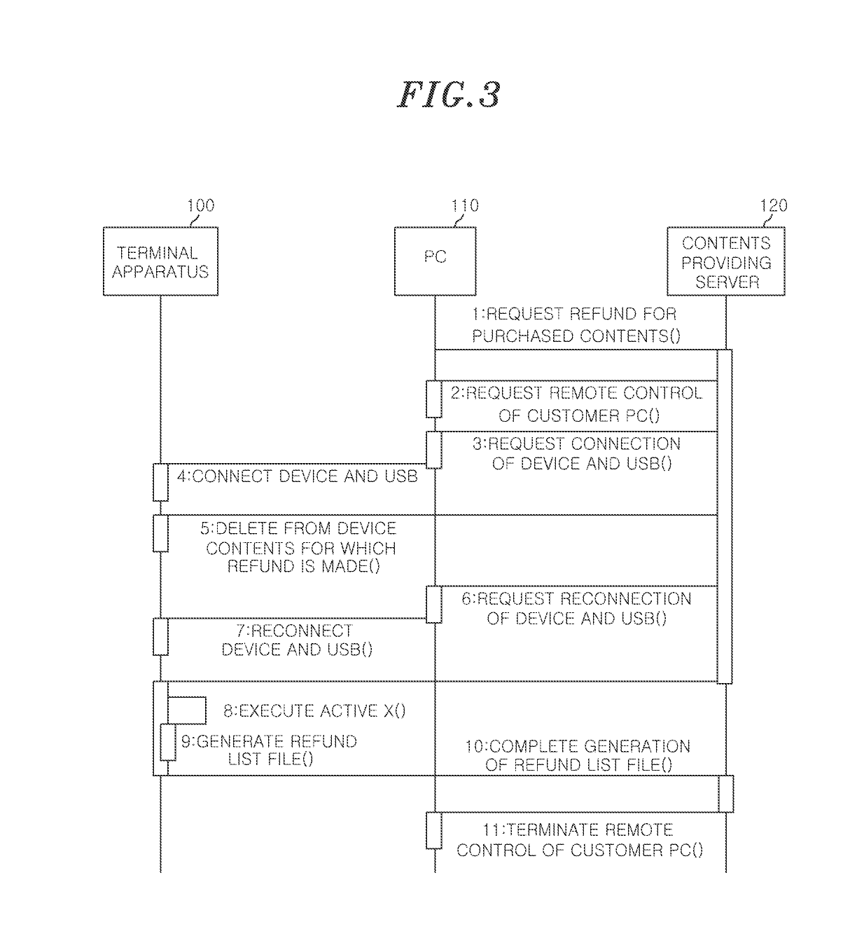

FIG. 3 is a flowchart for describing a sequence of a refunding process in accordance with an exemplary embodiment of the present disclosure. A purchaser who has purchased DRM-encrypted contents may access the contents providing server 200 by using their own PC 110 and request a refund for the purchased DRM-encrypted contents (1). Here, the request for the refund may be made through a refund-related web page screen provided by the contents provider 200.

In response, the contents providing server 200 may request a remote control of the PC 110 of the purchaser who has purchased the DRM-encrypted contents (2). Then, the contents providing server 200 may request the purchaser to connect the terminal apparatus 100, in which the DRM-encrypted contents to be refunded are stored, to the PC 110 of the purchaser (3).

In this case, the purchaser may connect the terminal apparatus 100, in which the DRM-encrypted contents to be refunded are stored, to the PC 110 of the purchaser through various connection mechanisms such as a USB (4).

Then, the contents providing server 200 may delete the refund-requested DRM-encrypted contents from the terminal apparatus 100 in which the DRM-encrypted contents to be refunded are stored.

Meanwhile, if the DRM-encrypted contents for which refund is requested by the purchaser is deleted from the terminal apparatus 100, the terminal apparatus 100 may execute a refund list generating program (8). Here, if the terminal apparatus 100 of the purchaser is not connected to the PC 110, the contents providing server 200 may request a reconnection of the terminal apparatus 100 of the purchaser to the PC 110. Then, after the purchaser reconnects the terminal apparatus 100 to the PC 110 in response to this request, the refund list generating program may be executed. Meanwhile, if the refund-requested DRM-encrypted contents are deleted from the terminal apparatus 100 in the state that the terminal apparatus 100 of the purchaser is connected to the PC 110, the refund list generating program may be immediately executed without waiting for the reconnecting process.

If the refund list generating program is executed, the terminal apparatus 100 of the purchaser may generate a refund list file (9) and notify the contents providing server 200 of completion of the generation of the refund list file (10). Then, the contents providing server 200 may terminate the remote control of the PC 110 of the purchaser 110.

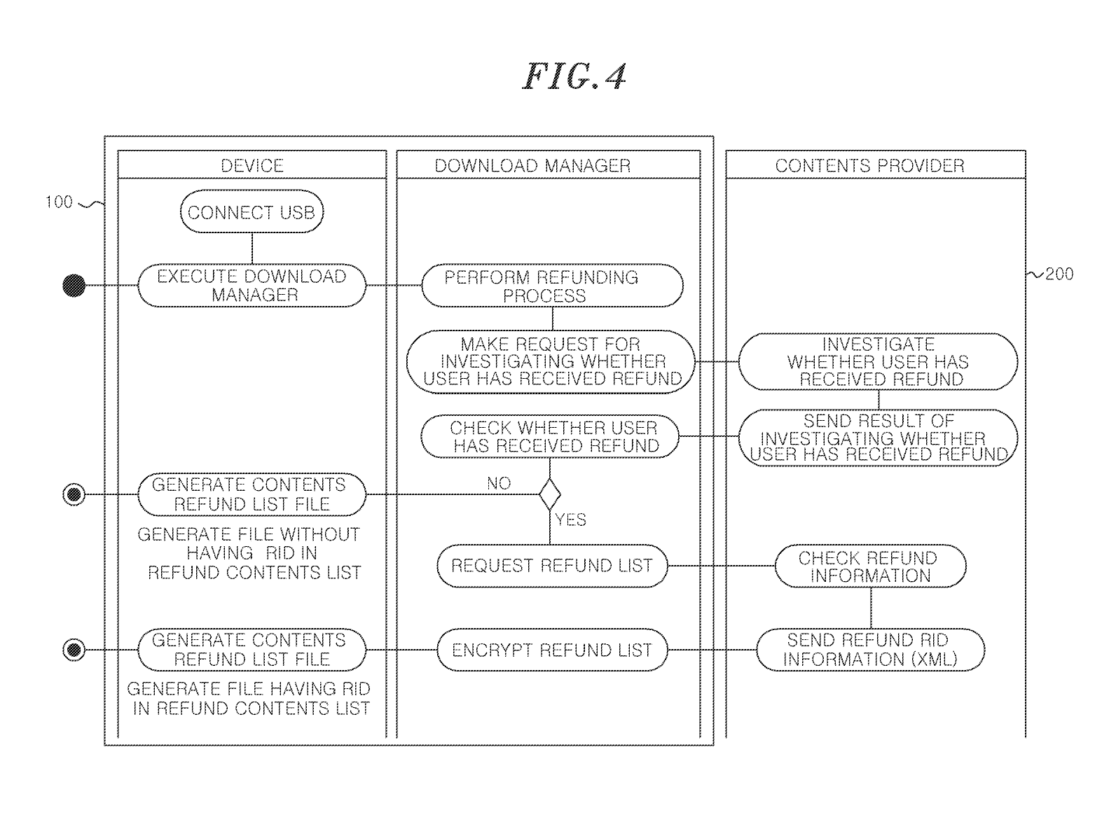

Here, the generation of the refund list file will be elaborated with reference to FIG. 4.

FIG. 4 is a flowchart for describing a method for generating a refund list file in accordance with an exemplary embodiment of the present disclosure. Referring to FIG. 4, after the terminal apparatus 100 is connected to the PC 110, the control unit 130 of the terminal apparatus 100 may execute the refund list generating program. Here, the refund list generating program may be, but not limited to, an Active X program.

When executed, the refund list generating program may be capable of implementing a refunding operation as follows in connection with the control unit 130 of the terminal apparatus 100.

To elaborate, the control unit 130 of the terminal apparatus 100 may control the communication unit 111 to send the contents providing server 200 a request for investigating whether the user of the terminal apparatus 100 has received a refund for the DRM-encrypted contents.

In response, the contents providing server 200 may identify the user based on identification information of the terminal apparatus 100 (for example, unique information such as a MAC address capable of distinguishing the terminal apparatus 10 from other terminal apparatuses), and may check whether there is a record indicating that the user has received a refund for DRM-encrypted contents. Then, the contents providing server 200 may send the terminal apparatus 100 the result of investigating whether the user of the terminal apparatus 100 has received the refund.

The control unit 130 of the terminal apparatus 100 may check the result of investigating whether the user of the terminal apparatus 100 has received the refund for the DRM-encrypted contents in connection with the refund list generating program.

If there is no record indicating that the user of the terminal apparatus 100 has received a refund for the DRM-encrypted contents, the control unit may generate a first refund list file in connection with the refund list generating program. In this case, since there is no DRM-encrypted contents for which the user of the terminal apparatus 100 has received a refund, the generated first refund list file may not include refunded contents identification information.

Meanwhile, if there is a record indicating that the user of the terminal apparatus 100 has received a refund for DRM-encrypted contents, the control unit 130 may control the communication unit 111 to send the contents providing server 200 a request for refund information of the user of the terminal apparatus 100.

In response, the contents providing server 200 may send the terminal apparatus 100 identification information of the DRM-encrypted contents for which the user of the terminal apparatus 100 has received the refund.

In this case, the control unit 130 may generate a second refund list file in connection with the refund list generating program. Here, the generated second refund list file may include identification information of the contents for which the user of the terminal apparatus 100 has received the refund.

Here, contents identification information may be information capable of distinguishing one contents from another.

The aforementioned refund list file may be generated repeatedly in connection with the contents providing server 200 whenever the refund list generating program is executed, whereby the refund list file can be updated to the newest.

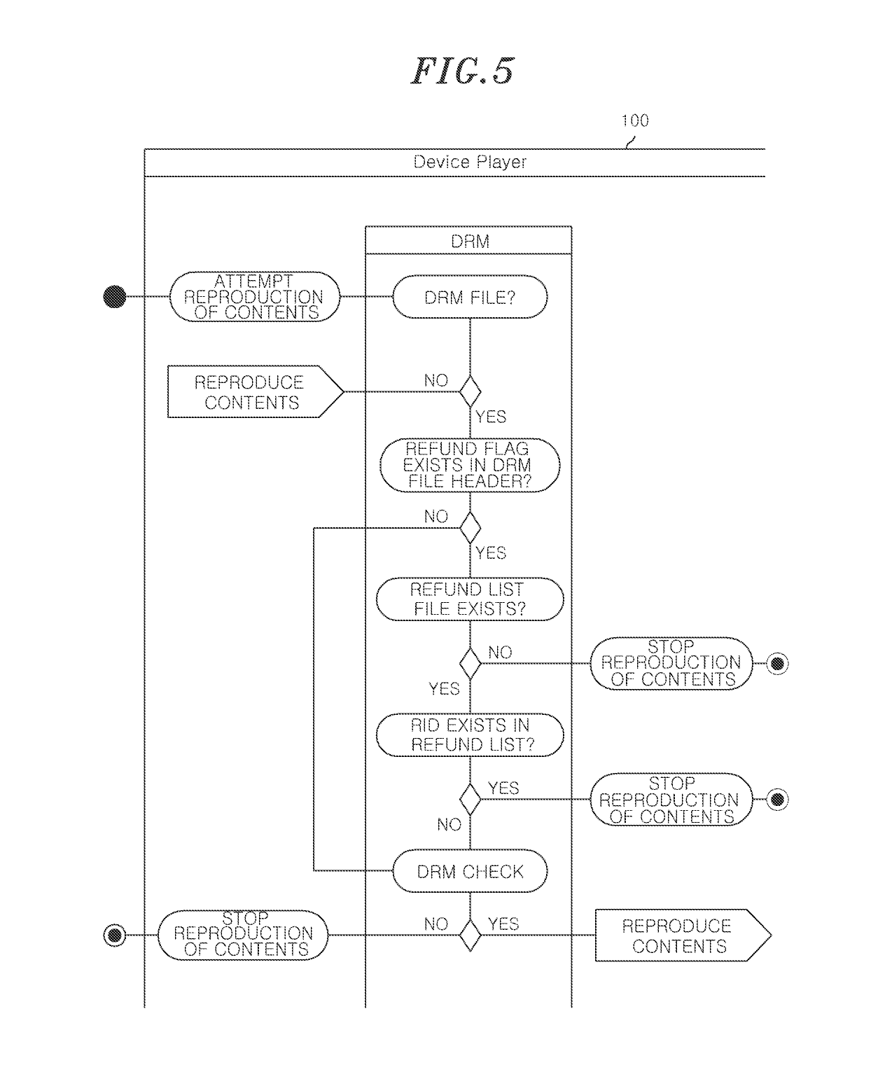

FIG. 5 is a flowchart for describing a sequence of a process for preventing an illegal use of DRM-encrypted contents for which a refund is made. Here, FIG. 5 will be described for an example case that the DRM-encrypted contents is reproducible contents such as film or music.

Referring to FIG. 5, the user of the terminal apparatus 100 may request reproduction of various contents stored in the storage unit 120. The control unit 130 of the terminal apparatus 100 may check whether the contents requested to be reproduced are DRM-encrypted contents. If the contents requested to be reproduced are not DRM-encrypted contents, the control unit 130 may reproduce the contents.

If, however, the contents attempted to be reproduced are found to be DRM-contents, the control unit 130 may check whether a refund flag exists in a header of the DRM-encrypted contents requested to be reproduced. If there is a refund flag in the header of the DRM-encrypted contents requested to be reproduced, the control unit 130 may check whether there is a refund list film in the terminal apparatus 100. If there exists no refund file list in the terminal apparatus 100, the control unit 130 may stop the reproduction of the DRM-encrypted contents requested to be reproduced. If there is found a refund file list, however, the control unit 130 may check whether contents identification information in the header of the DRM-encrypted contents requested to be reproduced is included in contents identification information in the refund list file. If so, the control unit 130 may stop the reproduction of the DRM-encrypted contents of which reproduction is requested.

Meanwhile, in case that there is no refund tag in the header of the DRM-encrypted contents requested to be reproduced, or in case that the contents identification information in the header of the DRM-encrypted contents requested to be reproduced is not included in the contents identification information in the refund list file, the control unit 130 may check whether a license is granted to the DRM-encrypted contents (DRM check).

If it is found that a license is not granted to the DRM-encrypted contents requested to be reproduced, the reproduction of the contents may be stopped. Meanwhile, if it is found that a license is granted to the DRM-encrypted contents requested to be reproduced, the contents may be reproduced.

According to the above-described various exemplary embodiments of the present disclosure, if there exists a refund flag in a header of DRM-encrypted contents in the terminal apparatus and if contents identification information in the header of the DRM-encrypted contents is included in contents identification information of a refund list file, the user of the terminal apparatus is not allowed to use the DRM-encrypted contents. Accordingly, after a refund for the contents is made, a misuse of those contents can be prevented. Thus, the contents provider can be guaranteed legitimate profit.

In the above description, the terminal apparatus 100 and the PC 110 are described to be connected to each other via a USB or the like, for example. However, in case that the terminal apparatus 100 and the contents providing server 300 are directly connected and a refunding process and a refund list file generating process can be performed therebetween, the PC 110 can be omitted from the system 1000.

Meanwhile, the method according to the various exemplary embodiments of the present disclosure may be implemented by program codes and provided to the respective servers or devices while stored on a non-transitory computer readable medium.

Here, the non-transitory computer readable medium implies a storage medium that stores data semi-permanently, unlike a storage medium such as a register, a cache or a memory that stores data for an instant, and that is readable by a device. By way of non-limiting example, the above-described various applications or programs may be provided while stored on a non-transitory computer readable medium such as a CD, a DVD, a hard disk, a blue-ray disk, a USB, a memory card or a ROM.

Although exemplary embodiments of the present disclosure are described above with reference to the accompanying drawings, those skilled in the art will understand that the present disclosure may be implemented in various ways without changing the necessary features or the spirit of the present disclosure. Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

### EXPLANATION OF CODE

100: Terminal apparatus
110: PC
200: Contents providing server
300: License generating server
111: Communication unit
120: Storage unit
130: Control unit

What is claimed is:

1. A DRM contents using method of a terminal apparatus, comprising:
generating a refund list file including contents identification information upon DRM contents for which a user of the terminal apparatus has received a refund;
if a use of first DRM contents is requested from the terminal apparatus, comparing first contents identification information corresponding to the first DRM contents with the contents identification information in the refund list file; and
determining usability of the first DRM contents based on the comparison result.

2. The DRM contents using method of claim 1,
wherein the process of generating the refund list file comprises:
sending, to a contents providing server, a request for investigating whether the user of the terminal apparatus has received a refund for DRM contents;
requesting contents identification information of the DRM contents for which the user of the terminal apparatus has received the refund;
generating the refund list file by using the received information upon whether the user has received the refund for the DRM contents and the contents identification information of the DRM contents for which the user has received the refund.

3. The DRM contents using method of claim 1, further comprising:
if the use of the first DRM contents is requested from the terminal apparatus, checking whether a refund flag is set in a header of the first DRM contents,
wherein the process of comparing the first contents identification information of the first DRM contents is performed when the refund tag is found to be set.

4. The DRM contents using method of claim 1,
wherein in the process of determining the usability of the first DRM contents,
based on the comparison result, if the first contents identification information is found to be included in the contents identification information in the refund list file, it is determined that the first DRM contents are not usable, and
based on the comparison result, if the first contents identification information is found not to be included in the contents identification information in the refund list film, it is determined that the first DRM contents are usable.

5. A terminal apparatus using DRM contents, comprising:
a storage unit configured to store therein a refund list file including contents identification information upon DRM contents for which a user of the terminal apparatus has received a refund;
a control unit configured to, if a use of first DRM contents is requested from the terminal apparatus, compare first contents identification information corresponding to the first DRM contents with the contents identification information in the refund list file, and determine usability of the first DRM contents based on the comparison result.

6. The terminal apparatus of claim 5, further comprising:
a communication unit,
wherein the control unit controls the communication unit to send, to a contents providing server, a request for investigating whether the user of the terminal apparatus has received a refund for DRM contents, and to request contents identification information of the DRM contents for which the user of the terminal apparatus has received the refund, and
the control unit generates the refund list file by using the received information upon whether the user has received the refund for the DRM contents and the contents identification information of the DRM contents for which the user has received the refund.

7. The terminal apparatus of claim 5,
wherein if the use of the first DRM contents is requested from the terminal apparatus, the control unit checks whether a refund flag is set in a header of the first DRM contents, and
the process of comparing the first contents identification information of the first DRM contents is performed if the refund tag is found to be set.

8. The terminal apparatus of claim 5,
wherein based on the comparison result, if the first contents identification information is found to be included in the contents identification information in the refund list file, the control unit determines that the first DRM contents are not usable, and
based on the comparison result, if the first contents identification information is found not to be included in the contents identification information in the refund list film, the control unit determines that the first DRM contents are usable.
